(19) United States
(12) Patent Application Publication
(10) Pub. No.: US 2012/0204687 A1
(43) Pub. Date: Aug. 16, 2012

(54) MEASUREMENT CLAMP DEVICE AND MEASUREMENT METHOD

(76) Inventor: Evans KALAMBOKAS, Greenwich, CT (US)

(21) Appl. No.: 13/207,616

(22) Filed: Aug. 11, 2011

Related U.S. Application Data
(60) Provisional application No. 61/386,714, filed on Sep. 27, 2010.

(51) Int. Cl. G01B 3/10; B26D 3/00

(52) U.S. Cl. 83/13; 33/758; 33/701

(57) ABSTRACT

A clamp device is provided for defining a reference for a measurement comprising: a receiving tray defining a first reference guide and a second reference guide disposed at an acute angle to said first reference guide; a wing projecting from said receiving tray and defining a reference edge which aligns with the vertex of the angle between said first and second reference guides and is orthogonal to said first reference guide; a handle projecting from said receiving tray; a second handle pivotally connected with said first handle and having a forward portion; a clamp plate pivotally mounted to said forward portion; and a biasing member which biases the handles apart so that said pivoting clamp plate is urged toward said receiving tray.

### CROSS REFERENCE TO RELATED APPLICATION

This application claims benefit to provisional patent application Ser. No. 61/386,714, filed 27 Sep. 2010, which is hereby incorporated by reference in its entirety.

### BACKGROUND OF THE INVENTION

1. Field of the Invention

This disclosure relates generally to devices employed for measurement and methods of measurement. More particularly, this disclosure relates to devices and methods employed in the carpentry trade and related technologies for ensuring proper measurement of materials.

2. Description of Related Art

In the carpentry and related technologies, precise and proper measurement for cutting materials is critical. Commonly, a measuring tape or measuring ruler is placed on the material. The measurement is undertaken and a mark is made on the material to indicate the cutting line. For a single craftsman to make the measurement and ensure the proper cut when very long materials are required, the measurement process can be problematic. The craftsman cannot, at the same time, be positioned at or reach the reference end of the material and the opposing portion where the measurement is to be indicated.

In some instances, the obtaining of a proper measurement is further complicated by the material geometry. For example, one end of the material, such as a frame piece, may have a mitred edge oriented at 45° to the longitudinal side. For traditional techniques, whereby the measuring rule has an engagement flange for engaging the end of the material, an angularly oriented end can significantly obstruct a proper reference for the measuring end.

### SUMMARY OF THE INVENTION

A clamp device is provided for defining a reference for a measurement comprising: a receiving tray defining a first reference guide and a second reference guide disposed at an acute angle to said first reference guide; a wing projecting from said receiving tray and defining a reference edge which aligns with the vertex of the angle between said first and second reference guides and is orthogonal to said first reference guide; a handle projecting from said receiving tray; a second handle pivotally connected with said first handle and having a forward portion; a clamp plate pivotally mounted to said forward portion; and a biasing member which biases the handles apart so that said pivoting clamp plate is urged toward said receiving tray.

Advantages of the the present invention include the following:
1) Holds the tape measure and trim securely
   Tape measure never slips.
   Accurately mark the cut spot on trim every time.
   Measurement is always exact.
2) Saves Time
   Trim windows and doors in half the time.
   No need to repeat inaccurately measured cuts!
3) Saves Money
   No need for a helper—trimming windows and doors is now a one person job.
   Perfect cuts the first time, every time.
   Reduces waste of expensive trim wood.

### BRIEF DESCRIPTION OF THE DRAWING

The drawing, which is not necessarily drawn to scale, includes the following:

FIG. 1 is a perspective view of a measurement clamp device according to some embodiments of the present invention;

FIG. 2 is a side elevational view of the measurement clamp device of FIG. 1;

FIG. 3 is a front elevational view of the measurement clamp device of FIG. 1;

FIG. 3A is a front elevational view of an alternative embodiment of a measurement clamp device of FIG. 3;

FIG. 3A′ is a diagram of a window frame showing a reveal formed by head, side and bottom casings;

FIG. 4 is a rear elevational view of the measurement clamp device of FIG. 1;

FIG. 5 is a perspective view of the measurement clamp device of FIG. 1 viewed from a slightly different angle;

FIG. 6 is a generally opposite side perspective view of the measurement clamp device of FIG. 1;

FIG. 7 is a top plan view of the measurement clamp device of FIG. 1;

FIG. 8 is a top perspective view of the measurement clamp device of FIG. 1 as employed for measuring an elongated and angled piece of material for cutting purposes; and

FIG. 9 is a perspective view of an alternative embodiment of a measurement clamp device.

In the following description of the exemplary embodiment, reference is made to the accompanying drawing, which form a part hereof, and in which is shown by way of illustration of an embodiment in which the invention may be practiced. It is to be understood that other embodiments may be utilized, as structural and operational changes may be made without departing from the scope of the present invention.

### DETAILED DESCRIPTION

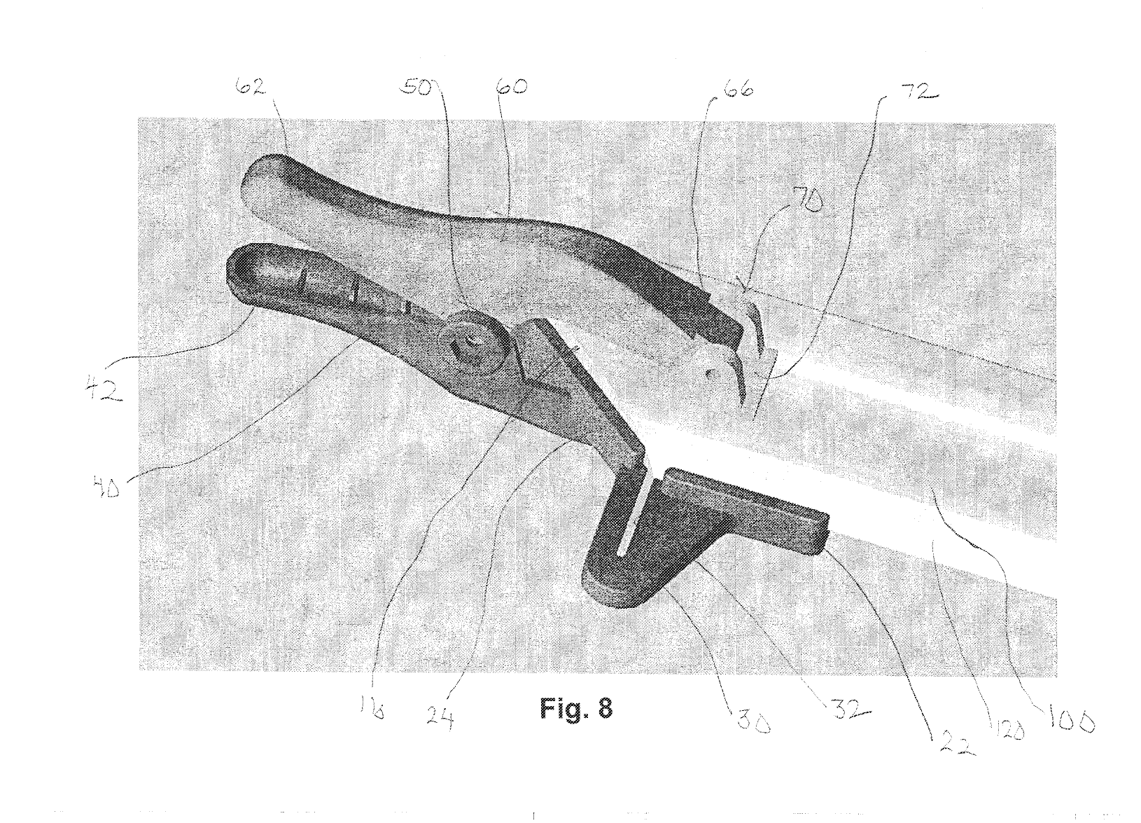

With reference to the drawing wherein like numerals represent like parts throughout the several Figures, a measurement clamp device is generally designated by the numeral 10. The clamp device 10 functions to facilitate the measurement of a long piece of material, such as a framing member, by providing a fixed and reliable reference position for a tape rule which has a stop or an engagement flange at the reference position. In particular, the clamp device 10 is especially adapted for use in measuring an elongated member with an end configured at about a 45° angle. By way of example, the elongated member, e.g., element 100 in FIG. 8, may include a piece of trim used for finishing a window or door in a building, especially around an opening, as well as for making a picture frame or the like for a photo or a piece of artwork, although the scope of the invention is intended to include other types or kinds of elongated members either now known or later developed in the future.

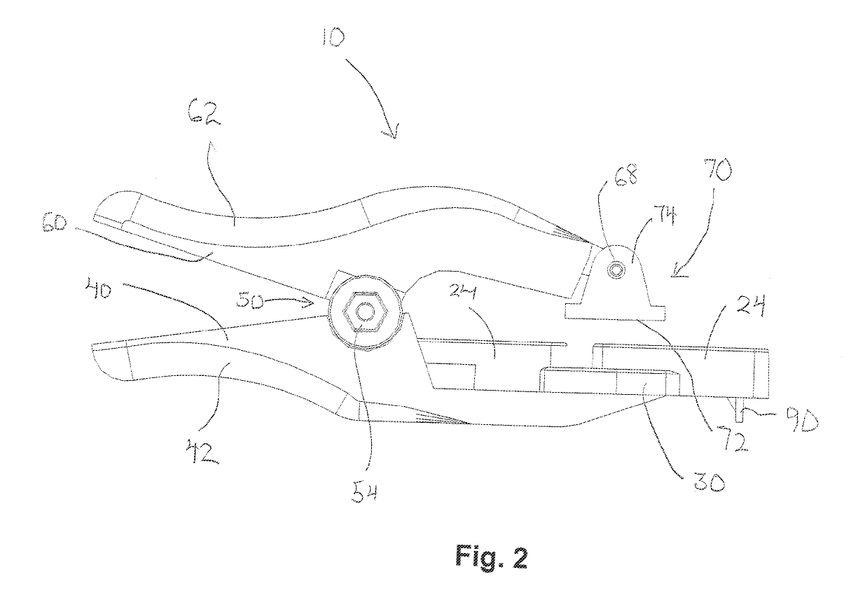

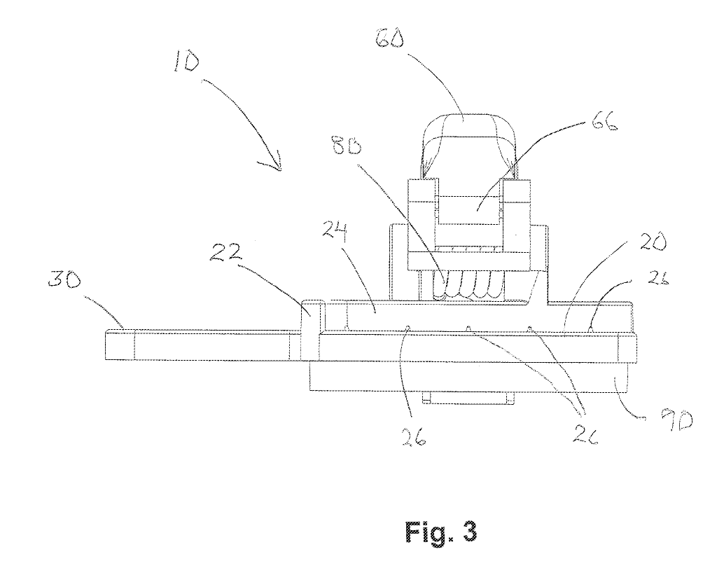

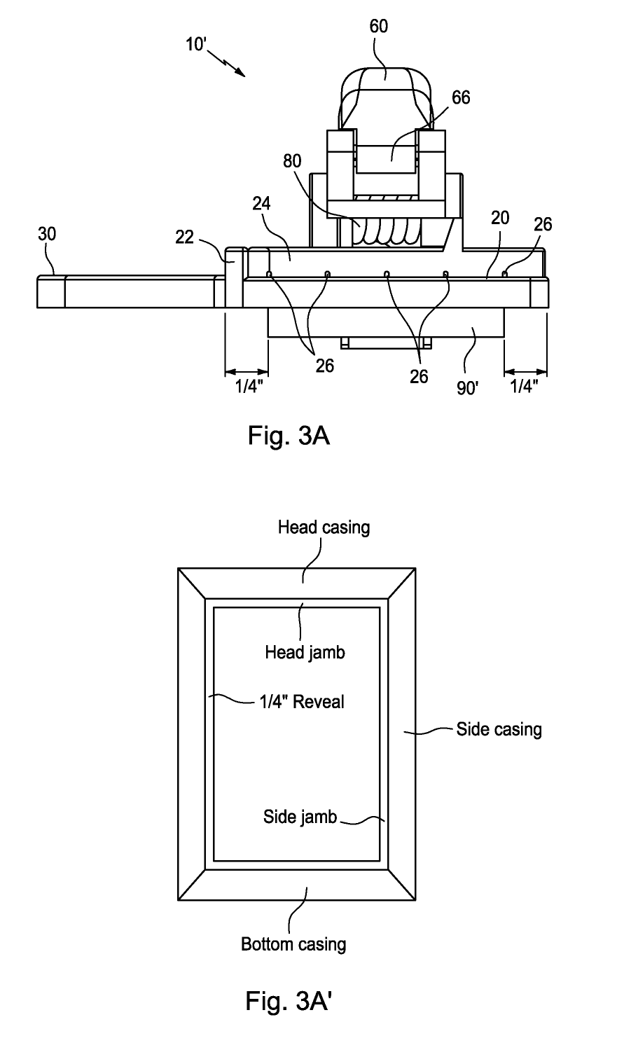

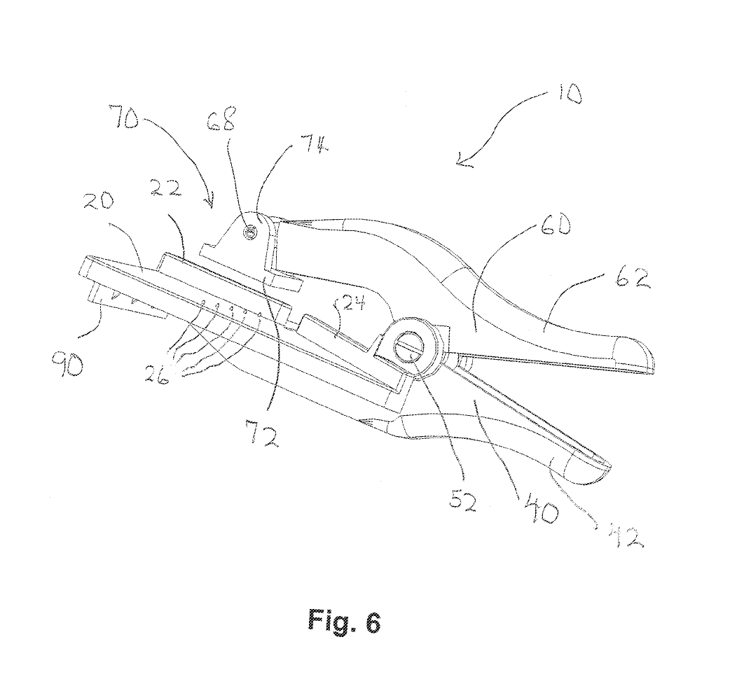

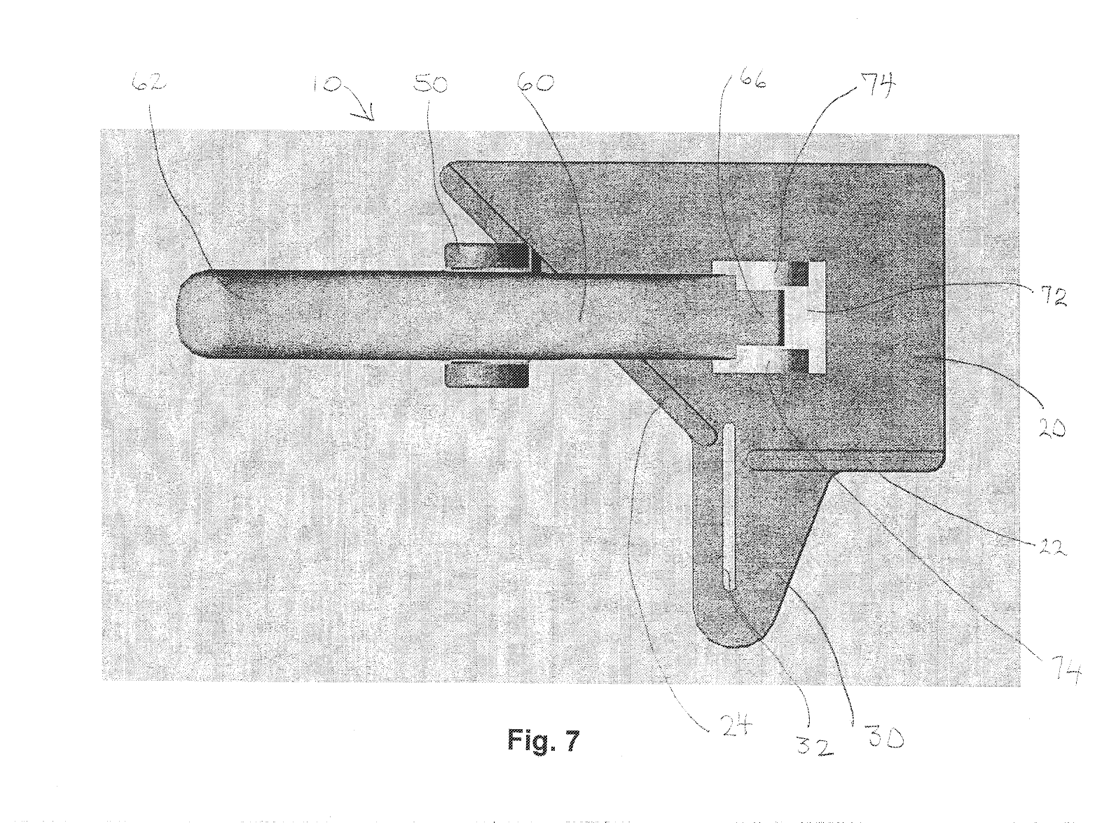

The clamp device 10, which is preferably formed from plastic or other low cost materials, includes an integral receiving tray 20. The receiving tray 20 forms a clamp bed which, in one preferred form, has a trapezoidal shape. The receiving tray 20 has an upright side reference guide 22 and an upright, angled end reference guide 24 (see FIG. 2) which cooperate to define reference positions for the member to be measured. A plurality of small prongs 26 (see FIG. 3) project upwardly from the clamp bed. In the preferred embodiment, the guide 24 is positioned at an angle of about 45° in relation to the front-to-back axis A of the clamp device 10, as indicated in FIG. 7. See also FIGS. 6 and 8-9. The scope of the invention is not intended to be limited to any particular angle, and embodiment are envisioned using other angles besides 45° within the spirit of the present invention.

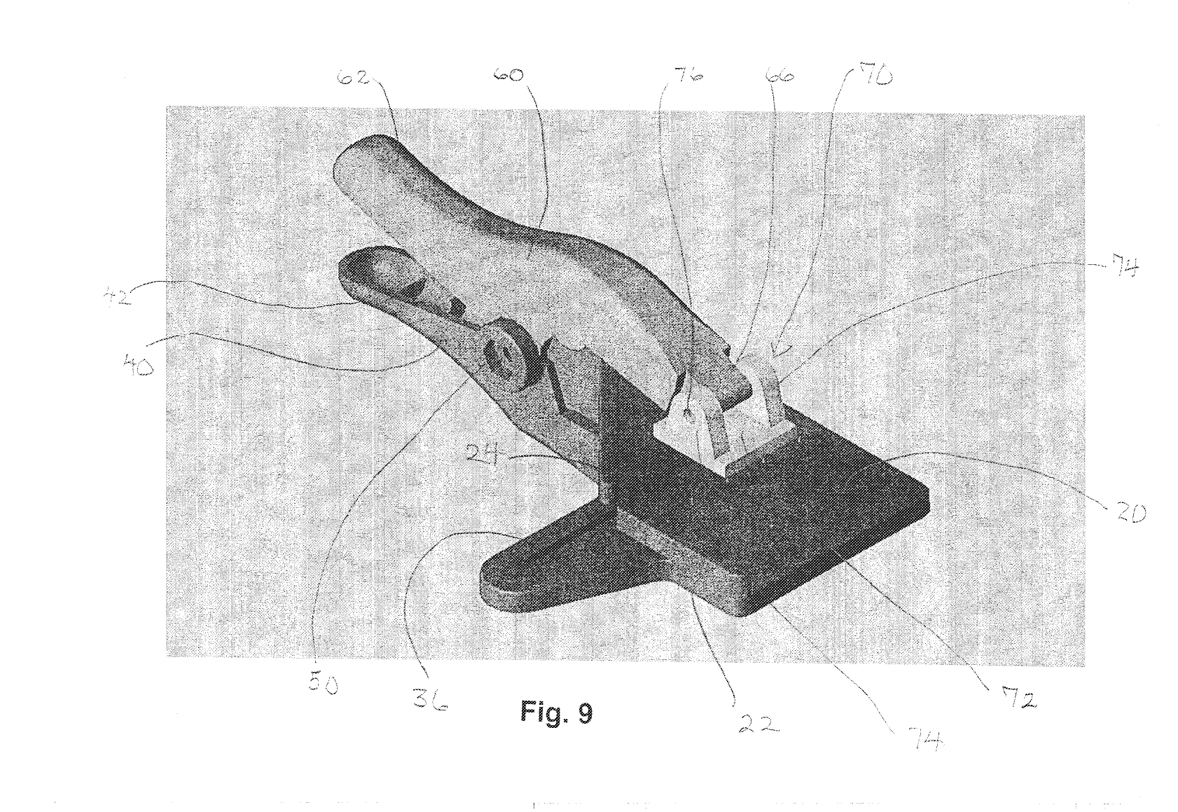

A protruding wing 30 projects from a side of the receiving tray 20. The wing 30 defines a slot 32 (best shown in FIG. 7) which generally aligns with the vertex of converging reference edges 22 and 24. In some embodiments or forms of the clamp device 10, the wing 30 may not have a slot as such, but merely a recessed portion (FIG. 9) with a reference edge 36 orthogonal to the reference edge and intersecting the vertex of the reference guides 22 and 24 of the receiving tray 20.

A first handle 40 projects rearwardly from the receiving tray 20. The handle 40 is contoured on its lower exterior to facilitate manual grasping of the handle. The handle 40 may have an open shell form which is bifurcated to form opposed sides with cross ribs and include openings at the opposed sides for receiving a pivot pin assembly generally indicated by arrow 50. In one embodiment, the pivot pin assembly 50 includes a 10/32 round head screw 52 and a 10/32 nut 54.

A second handle 60 is also preferably bifurcated with opposed sides and includes at its rear portion 62 a contoured shape for facilitating coordinated manual grasping with the rear portion 42 of the handle 40. The handle 60 includes a pair of transversely opposed openings which are alignable with the corresponding openings of the handle 40 so that the pivot pin or screw 52 may be inserted through the openings to permit pivotal movement of the handle 60 about the pin and relative to the handle 40 and the receiving tray 20.

The forward end of handle 60 includes a nose 66 which has a pair of opposed pins 68. A pivoting clamp plate 70 includes a plate 72 and a pair of substantially identical transversely spaced brackets 74 which include openings 76. The pins 68 extend into the openings 76 to pivotally mount the clamp plate 70 to the handle 60.

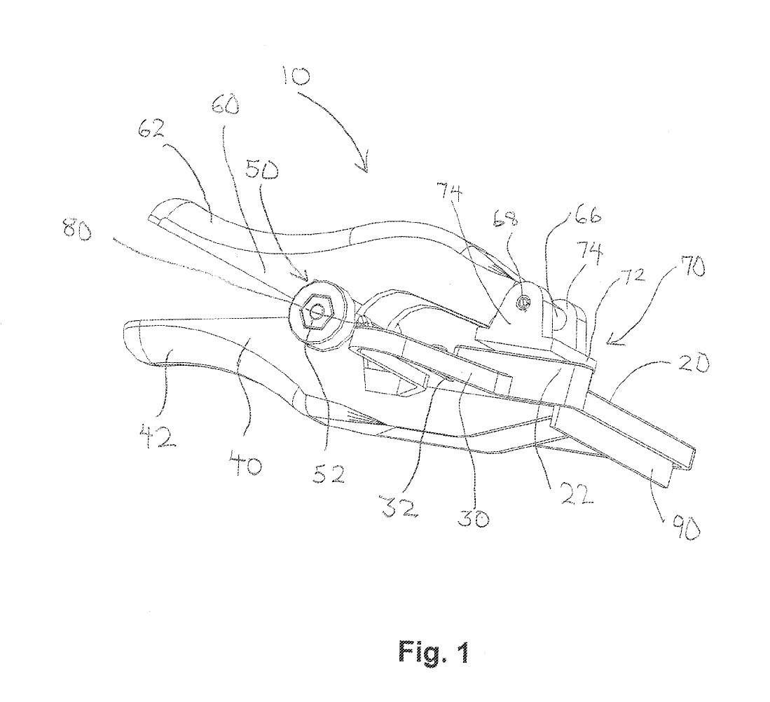

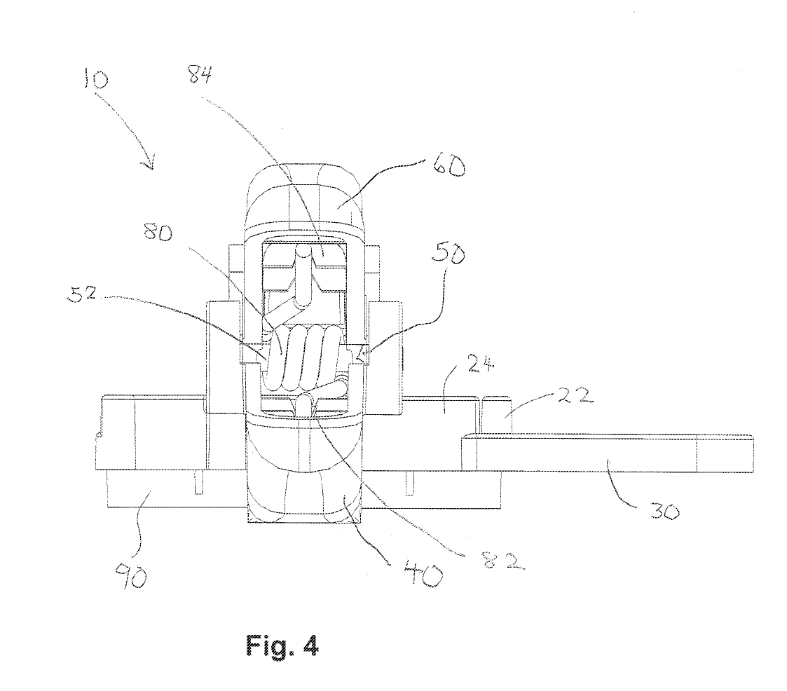

A torsion spring 80 (see FIG. 3) disposed about the pivot pin 52 includes engagement ends which engage V-shaped seats 82 and 84 (FIG. 4) formed in ribs of handles 40 and 60. The spring 80 urges the rear portions of the clamp member apart so that, for example, in the drawing of FIG. 1, the member handle 60 is urged to rotate clockwise relative to the stationary handle 40. Other spring or biasing arrangements are also possible.

It should be appreciated that the pivotal connections of the handles 40 and 60 and the pivotal connection of the pivoting clamp plate 70 with the handle 60 may also be accomplished in a number of alternative ways, such as integral protruding truncated axles and detents and other pivoting arrangements.

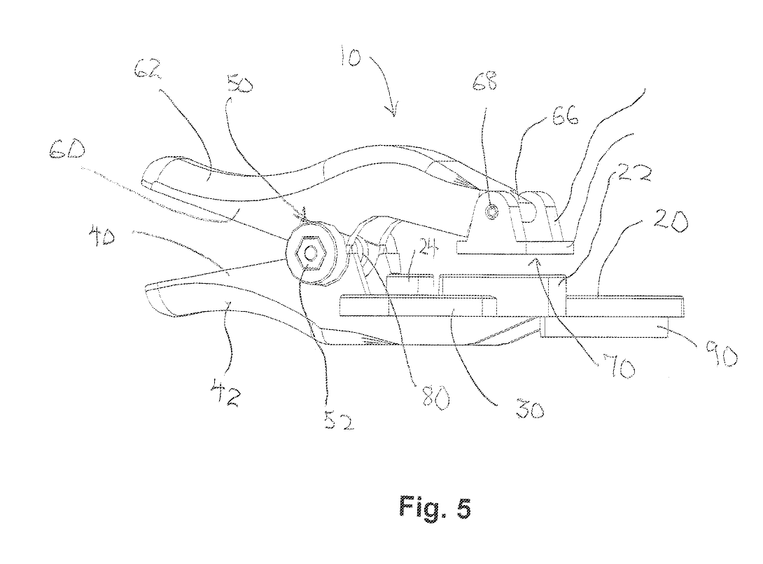

A lateral fence 90 integrally extends from a bottom of the receiving tray 20 to incorporate a reveal application as shown in FIG. 3, which would typically take the form of a ¼ inch reveal application, as shown by way of example in FIG. 3A. (See also the lateral fence 90 shown in FIGS. 1-2 and 4-6.) In particular, FIG. 3A shows an embodiment in which the revision on the Miter aid reveal fence is reduced ¼ inch on both sides so as to form a ¼ inch lateral reveal fence 90′ when compared to the embodiment of the lateral fence 90 shown in FIG. 3. The purpose of this ¼ inch reduction is to allow the clamp device 10′ to be used to mark horizontal and vertical reveal lines that meet in a perpendicular fashion, when drawn on the frame on a window or door, so that the head, side and bottom casings may be measured, cut and tacked in place so as to leave a ¼ inch reveal as shown in FIG. 3A′. As a person skilled in the art of carpentry would appreciate, the reveal is the distance between the inside of the jamb and the edge of the casing, which is typically ¼ inch, although the scope of the invention is not intended to be limited per se to any particular dimension of the reveal to be marked.

With additional reference to FIG. 8, the clamp device 10 functions in a very efficient manner to ensure a proper measurement of an elongated member for cutting, such as the elongated member 100 which has a 45° angle at one end 110 of the material. The handles 40 and 60 are squeezed at the rearward portions to force open the clamp device 10 to allow the end of the elongated member 100 to be fully seated on the receiving tray 20, as shown. The angled end 110 is received on the receiving tray 20 and abuts against the reference guide 24 and the elongated edge 120 abuts against guide 22. The handles 40 and 60 are then released so that the clamp plate 72 clamps or presses against the upper surface of the elongated member 100, thus clamping the elongated member 100 at the proper reference position with the clamp device 10. The plurality of prongs 26 function to provide a slip-free clamped relationship with the member.

The flange end of the measuring tape (not illustrated) may then be inserted into the slot 32 or the reference edge 36, and the measuring tape may be uncoiled until the proper measurement is obtained. A mark may then be placed on the elongated member 100 to indicate the proper cutting length. It will be appreciated that the measurement of the elongated member 100 is accurately achieved by a single craftsman, even though the end of the board may have about a 45° cut. It should be appreciated that, for certain specific applications, the reference guide 24 may be disposed at various alternative angles and/or the reference guide 24 may be variably positionable at various angles according to a given application.

### The Scope of the Invention

It should be understood that, unless stated otherwise herein, any of the features, characteristics, alternatives or modifications described regarding a particular embodiment herein may also be applied, used, or incorporated with any other embodiment described herein. Also, the drawings herein are not drawn to scale.

Although the invention has been described and illustrated with respect to exemplary embodiments thereof, the foregoing and various other additions and omissions may be made therein and thereto without departing from the spirit and scope of the present invention.

1. A clamp device for defining a reference for a measurement comprising:
a receiving tray defining a first reference guide and a second reference guide disposed at an acute angle to said first reference guide;
a wing projecting from said receiving tray and defining a reference edge which aligns with the vertex of the angle between said first and second reference guides and is orthogonal to said first reference guide;
a handle projecting from said receiving tray;
a second handle pivotally connected with said first handle and having a forward portion;
a clamp plate pivotally mounted to said forward portion; and
a biasing member which biases the handles apart so that said pivoting clamp plate is urged toward said receiving tray.

2. The clamp device of claim 1 wherein said reference edge is defined by a slot in said wing.

3. The clamp device of claim 1 wherein said receiving tray comprises a plurality of projecting prongs.

4. A method for measuring an elongated member for cutting purposes having a first end and an opposed second end which is angled to the longitudinal side of the member comprising:
clamping a device having a transversely projecting reference edge to the angled end of the member;
placing a stop or flange of a measuring tape against the reference edge;
using the tape to determine the cutting line on the member; and
marking the cutting line on the member;

5. The method of claim 4 and further comprising cutting the member using the cutting line.
